(19) United States
(12) Patent Application Publication
(10) Pub. No.: US 2002/0081173 A1
(43) Pub. Date: Jun. 27, 2002

(54) Apparatus for loading a substrate onto a processing surface in a thin-film processing chamber

(75) Inventors: Roger J. W. Croad, Somerset (GB); Andrew L. Goodyear, North Somerset (GB); Ivaylo W. Rangelow, Baunatal (DE); Burkhard Volland, Kassel (DE)

Correspondence Address: STAAS & HALSEY LLP, 700 11TH STREET, NW, SUITE 500, WASHINGTON, DC, 20001, US

(73) Assignee: Oxford Instruments Plasma Technology Limited, Oxfordshire (GB)

(21) Appl. No.: 10/003,239

(22) Filed: Dec. 6, 2001

(30) Foreign Application Priority Data
Dec. 21, 2000 (EP) 00311559.9

(51) Int. Cl. B65G 49/07

(52) U.S. Cl. 414/217

(57) ABSTRACT

The present invention provides apparatus for loading a substrate (65) onto a processing surface (61) in a thin-film processing chamber (60). The apparatus includes a support (66) which cooperates with one or more corresponding apertures (62) in the processing surface so as to be movable between an extended position in which the support can support a substrate (65) above the processing surface (61), and a retracted position in which the support is flush with or located below the processing surface (61). The support has a number of limbs (64) which extend radially outwardly from a central hub, at an angle relative to the processing surface. The limbs contact the edges of different sized substrates in use so as to support the substrate in a support plane above the central hub and substantially parallel to the processing surface.

The present invention relates to apparatus for loading a substrate onto a processing surface in a thin-film processing chamber.

Thin-film processing chambers are used for processing substrates, such as silicon wafers, by either etching the substrate or depositing additional material onto the substrate. Such processing chambers include a processing surface onto which the substrate must be loaded before processing. These substrates are generally very delicate in nature and it is therefore important that the loading procedure does not subject the substrate to undue levels of stress which result in the substrate becoming damaged.

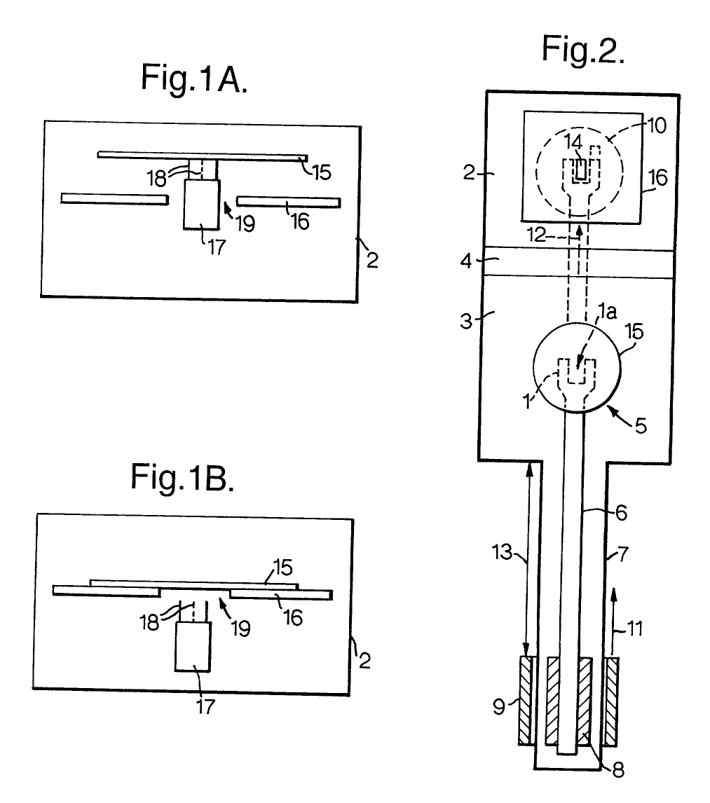

One example of loading apparatus that has previously been used is shown in FIG. 1A. This comprises of a processing chamber 2 including a support 17 which projects through an aperture 19 of a processing surface 16. The support 17 includes three arms 18 which extend vertically upwards from the support 17 so as to contact the underside of a substrate 15, as shown. In use, once the substrate 15 is positioned on top of the arms 18 the support 17 is lowered to the position shown in FIG. 1B so that the substrate 15 is lowered on to the processing surface 16.

In general, whilst the substrate 15 may be placed on the arms 18 by hand, a loading arm is preferably used to aid the loading procedure. An example of such a suitable loading arm system is shown in FIG. 2.

In this case, the processing chamber is coupled to a loading chamber 3 via a valve 4. Before loading commences, the substrate 15 is manually loaded onto a substrate holder 1. The loading chamber 2 is then evacuated so it is at the same pressure as the processing chamber 2 and the valve 4 is opened.

The substrate holder 1 is fixed to a distal end 5 of a loading arm 6. The arm 6 extends from the rear of the loading chamber 3 into a loading arm chamber 7 (also evacuated). The rear end of the loading arm chamber 7 is fitted with a suitable magnetic material 8 which is attracted to a cylindrical magnetic slider 9 which is slidably mounted to the exterior of the loading arm chamber 7. The substrate holder 1 is then transferred into the processing chamber 2 by manually sliding the magnetic slider 9 as indicated at 11.

This causes the loading arm 6 to move with the slider 9, consequently causing the substrate holder 1 to move into the loading position as indicated by dotted lines at 10. The distance of travel 12 of the substrate holder 9 is limited by the allowable extent of travel 13 of the slider 9.

Once the loading arm 6 is positioned in the processing chamber 2, the support 17 is raised from the retracted position shown in FIG. 1B. As shown in FIG. 2, the substrate holder 1 includes a recess 1a which is configured such that as the support is raised, the arms 18 pass through the recess 1a and engage the underside of the substrate 15. This action raises the substrate 15 clear of the substrate holder 1 such that the loading arm 6 may be removed from the processing chamber, whilst the substrate 15 remains supported by the arms 18. The support 17 is then lowered to the position shown in FIG. 1B to leave the substrate 15 in contact with the processing surface 16.

Unfortunately, such a system has the disadvantage that the arms 18 contact the lower surface of the substrate 15. As mentioned above, the substrates are particularly delicate and this operation can therefore cause significant damage to the substrate.

In accordance with the present invention, we provide apparatus for loading a substrate onto a processing surface in a thin-film processing chamber, the apparatus comprising a support which cooperates with one or more corresponding apertures in the processing surface so as to be movable between an extended position in which the support can support a substrate above the processing surface, and a retracted position in which the support is flush with or located below the processing surface, wherein the support comprises a number of limbs extending radially outwardly from a central hub, at an angle relative to the processing surface, the limbs being configured to contact the edges of different sized substrates in use so as to support the substrate in a support plane substantially parallel to the processing surface, the support plane being provided above the central hub.

Accordingly, the present invention provides apparatus for loading a substrate onto a processing surface which does not contact the lower surface of the substrate. Instead, the limbs of the support are designed to contact the edges of the substrate whilst supporting the substrate substantially parallel to the processing surface. The support can then be lowered allowing the substrate to be gently placed on the processing surface. Furthermore, by having the limbs extend at angle offset to the processing surface, the limbs can be used to support any size of substrate.

Typically each end defines a continuous support surface extending at an angle relative to the processing surface, each support surface contacting the edges of different size substrates in use. The use of the angled support surface allows a simple construction to used which can support any size of substrate and allow this to be easily loaded onto the processing surface. Alternatively however each limb may define a number of support surfaces, with each support surface being associated with a respective support plane. In this configuration, the limb will effectively consist of a number of steps with the corresponding steps of each limb being configured to accept a different size of substrate. This again allows different sizes of substrate to be easily loaded on to the processing surface.

Typically the apparatus further comprises a loading arm having a mounting which receives a substrate in use, the loading arm being movable between the retracted position and an extended position in which the mounting and support cooperates such that, in use, motion of the support to the extended position causes the substrate to be supported by the support, thereby removing the substrate from the mounting. As will already be realised, this provides apparatus having a simple construction which allows the substrate to be automatically loaded onto the processing surface within the processing chamber. However, any suitable means for placing the substrate on to the support, such as hand loading, or the use of a robotic arm, may be used. In the case in which a robotic arm is used, the robotic arm is typically arranged with a number of processing chambers circumferentially spaced around it, thereby allowing the arm to be used to load substrates into a number of different processing chambers in turn.

Typically the mounting comprises a number of mounting elements extending radially outward from a central portion, each mounting element defining a number of mounting surfaces and each mounting surface being associated with a respective mounting plane. In this configuration, each mounting element will effectively consist of a number of steps, with each step defining a mounting surface. The corresponding mounting surfaces of each limb are then configured to accept a different size of substrate so that a separate mounting position is defined for each different size of substrate that is to be used. In use, the substrate is positioned on the steps defined by the mounting surfaces, thereby ensuring that the substrate is in the optimum position for subsequent processing. It will however be realised that alternative designs could be used.

The apparatus further comprises a drive means for controllably moving the loading arm between the extended or retracted positions. Alternatively however the loading arm may be simply moved by hand.

Typically, apparatus further comprises an actuator for controllably moving the support between the extended and retracted positions. This advantageously allows the substrate to be gently lowered onto the processing surface to thereby further reduce the risk of damage to the substrate.

Preferably the apparatus further comprises a clamp movable between an open position and a clamping position for clamping the substrate to the processing surface. This allows the substrate to be held in position whilst processing occurs. It will however be realised that this will not be essential in all circumstances.

Typically the clamp comprises an annular clamping element extending radially inwardly from an outer clamping ring the clamping ring being positioned radially outwardly from the processing surface. This allows the clamp to be configured to only touch the outer edge of the substrate, thereby reducing the amount of damage that can occur to the substrate, during processing.

The use of an annular clamping element ensures that the substrate is clamped along the entire circumference of its upper surface. This ensures that a strong clamping force can be applied evenly to the substrate thereby ensuring that the substrate is held in place. Furthermore by ensuring that the clamping force is even over the entire surface of the substrate, this helps prevent bending or fracturing of the substrate by the clamping element.

However, if less clamping force is required it is also possible to use a number of separate clamping elements each of which extends radially inwardly from the outer clamping ring. In this case, typically three elements would be provided circumferentially spaced around the annular clamping ring so that the substrate is clamped at three positions around the circumference of its upper surface. This will however generally provide less clamping force and provides an increased risk of fracture during use.

Typically the apparatus further comprises a clamp actuator for moving the clamp between the open clamping positions, the clamping ring being removably mounted to the clamp actuator. This allows the clamp to be configured to automatically clamp the substrate when it is in position on the processing surface. Furthermore, the clamping ring can be removed from the actuator and replaced with a clamping ring having alternative clamping elements. This allows substrates of different sizes to be suitably clamped to the processing surface.

Typically the apparatus further comprises a controller for control of the moving support on the loading arm between their respective retracted unextended positions. This allows the substrates to be automatically loaded onto the processing surface, thereby removing the need for operator intervention.

Conveniently, the apparatus further comprises a loading assembly having a mounting which receives a substrate in use, the loading assembly being movable between a retracted position in which the mounting is outside the processing system chamber and an extended position in which the mounting is inside the processing system chamber, and wherein the mounting comprises a number of mounting elements extending substantially radially outwardly from a central position, each mounting element defining a number of mounting surfaces, and each mounting surface being associated with a respective mounting plane, and wherein the mounting and the support cooperate such that, in use, with the loading assembly in the extended position, motion of the support to the extended position causes the substrate to be supported by the support, thereby removing the substrate from the mounting.

Accordingly, the present invention also provides apparatus for loading a substrate into a thin-film processing system chamber which comprises a loading assembly having a mounting which receives the substrate. The mounting includes a number of mounting elements each of which defines a number of mounting surfaces by using a stepped arrangement. Each mounting surface is associated with a respective mounting plane and is designed to accept different sizes of substrate. The system is arranged in this configuration so that a separate mounting position is defined for each different size of substrate to be used. Accordingly, by mounting a substrate in the respective mounting plane defined by the appropriate mounting surfaces, this ensures that the substrate is always located in the optimum position for subsequent loading in to the processing chamber and subsequent processing.

In this situation, with the mounting designed to hold the substrate in the correct position, this ensures that the substrate is correctly loaded onto the processing surface.

Thus, the mounting is adapted so that in use a substrate positioned on the mounting in the respective mounting plane will be located substantially over the centre of the processing surface when the loading assembly is in the extended position.

The apparatus usually further comprises a drive means for controllably moving the load and between the extended retracted positions.

In this case, the loading assembly typically comprises a carriage, first drive means for driving the carriage with respect to a base, a second drive means which moves with the carriage and cooperates with the base whereby the relative movement between the carriage and the base causes the second drive means to drive the mounting with respect to the carriage. However, this is not essential and any suitable loading assembly, such as a loading arm or robotic arm may be used.

When the above mentioned configuration is used the current is slidably mounted to the base and the mounting is slidably mounted to the carriage.

Accordingly, the present invention also provides a thin film processing system comprising one or more processing chambers in which substrates are processed and a loading apparatus according to the present invention.

Examples of the invention will now be described with reference to the accompanying drawings, in which:

FIG. 1A and 1B show apparatus for loading a substrate according to the prior art;

FIG. 2 shows a loading arm according to the prior art;

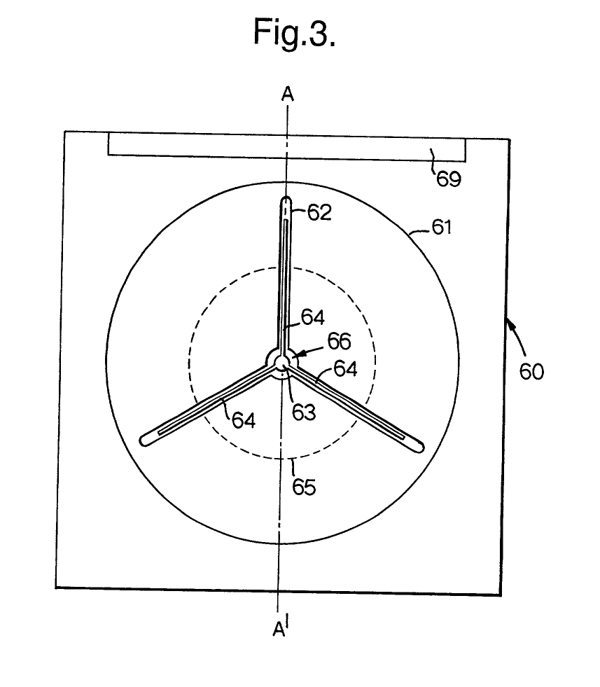

FIG. 3 shows a plan view of a first example of a substrate loading apparatus according to the invention;

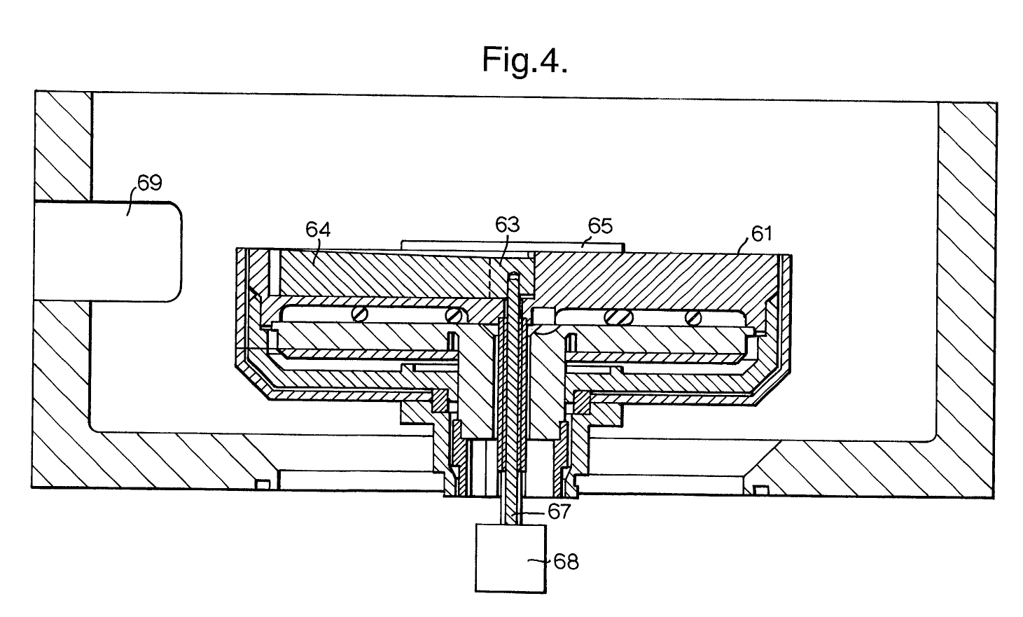

FIG. 4 shows a cross section along the line A-A′ of the apparatus of FIG. 3 in its retracted position;

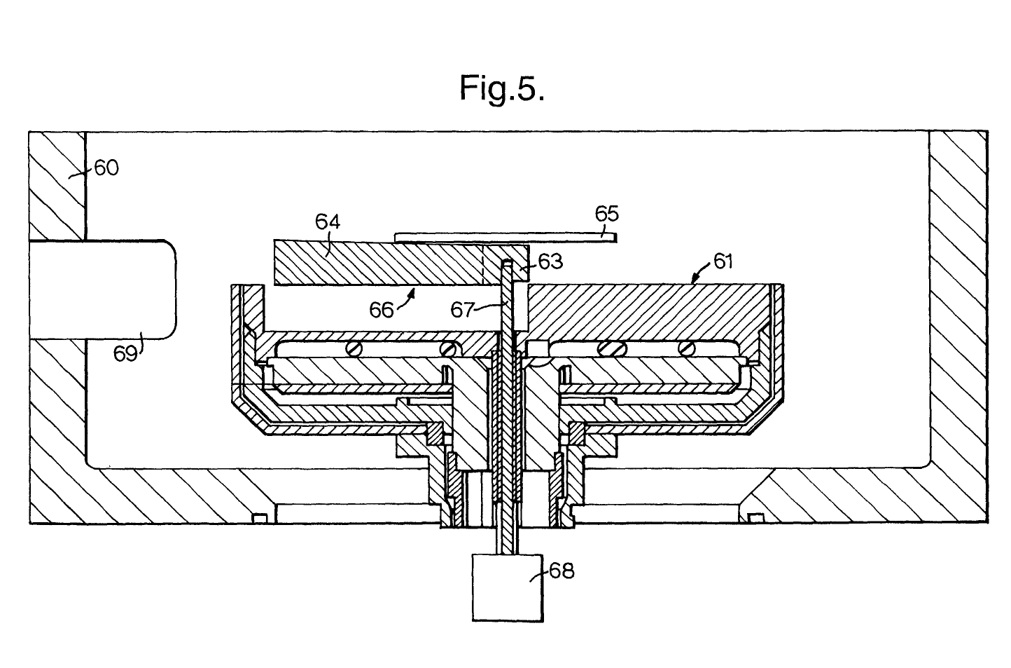

FIG. 5 shows a cross section along the line A-A′ of the apparatus of FIG. 3 in its extended position;

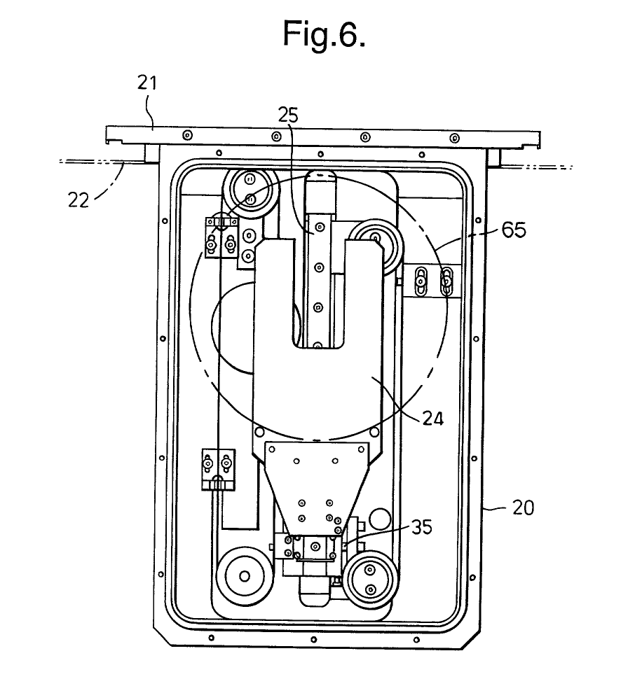

FIG. 6 shows a loading arm, suitable for use with the apparatus of FIG. 3, in its retracted position;

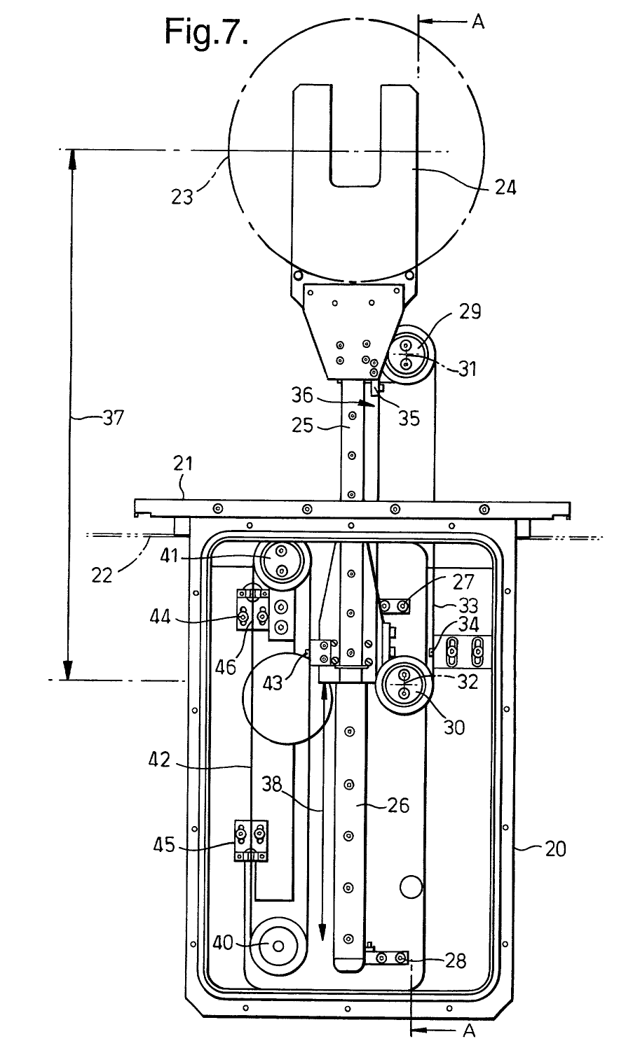

FIG. 7 shows the arm of FIG. 6 in its extended position;

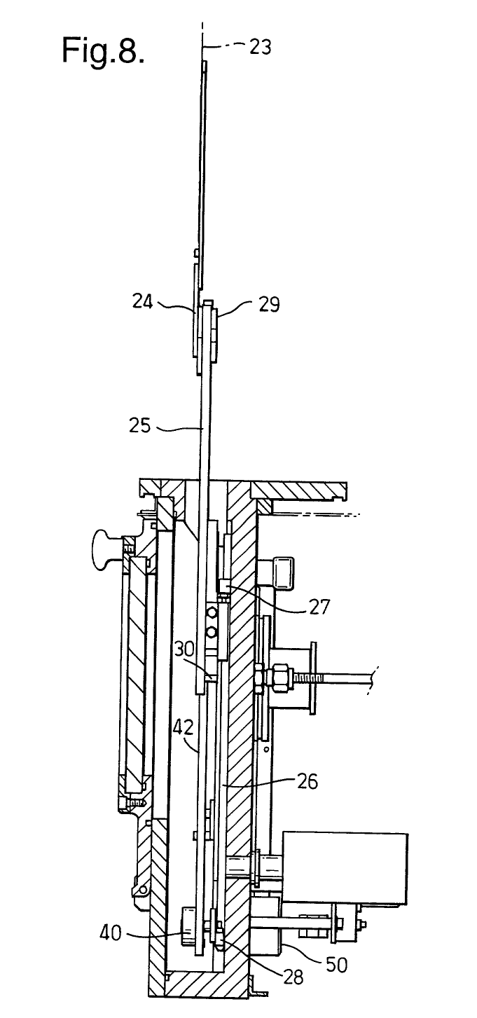

FIG. 8 is a cross-section of FIG. 6 along a line 3B-B′;

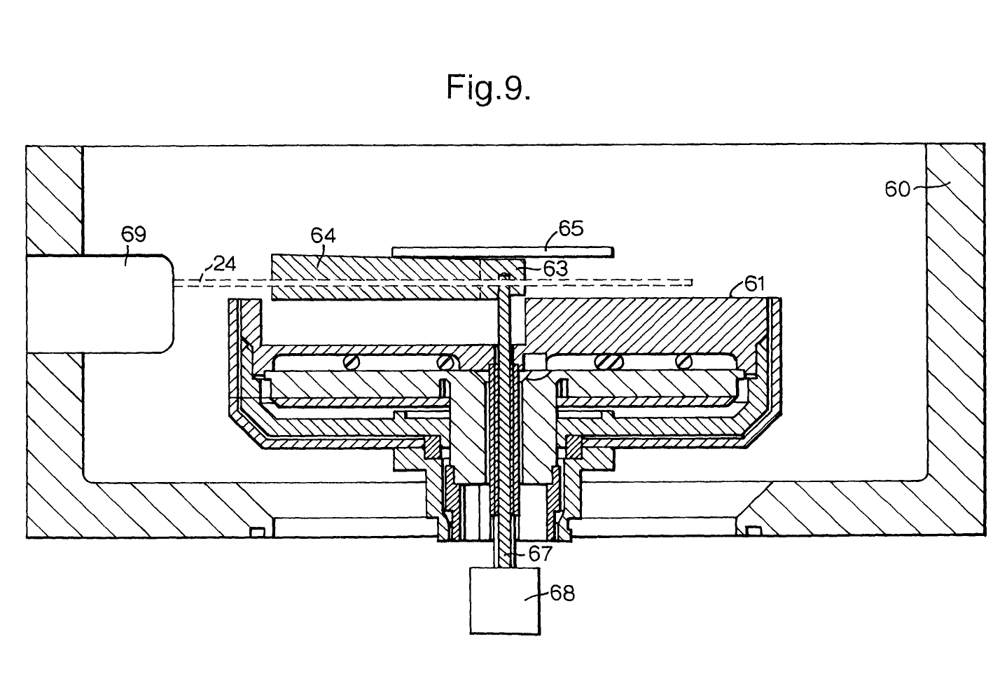

FIG. 9 shows a cross section along the line B-B′ of the apparatus of FIG. 2 in its extended position in conjunction with the loading arm of FIG. 6;

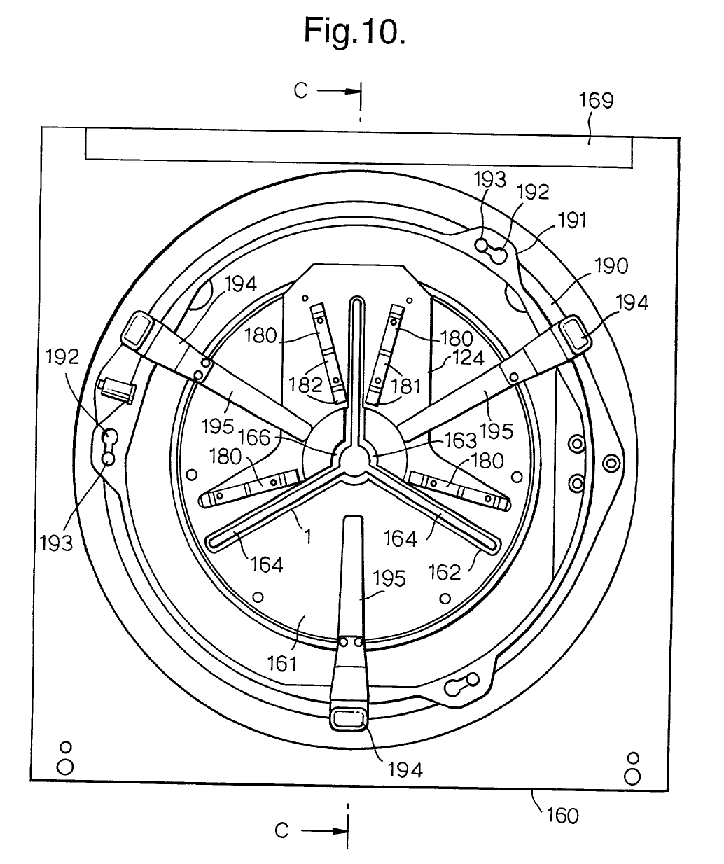

FIG. 10 shows a plan view of a second example of a substrate loading apparatus according to the invention;

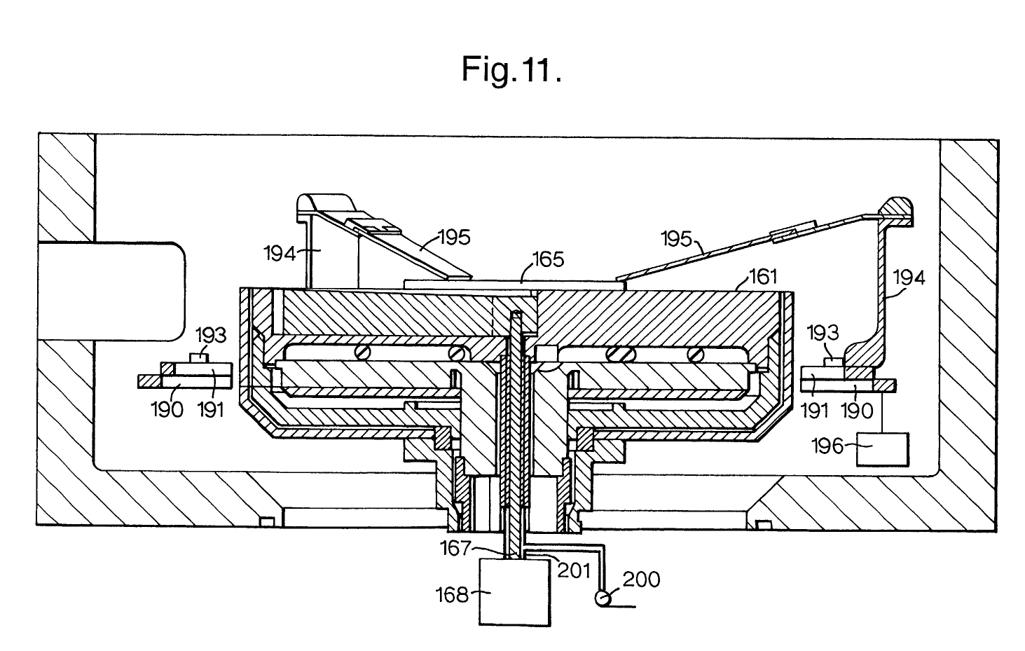

FIG. 11 shows a cross section along the line C-C′ of the apparatus of FIG. 10 in its retracted position;

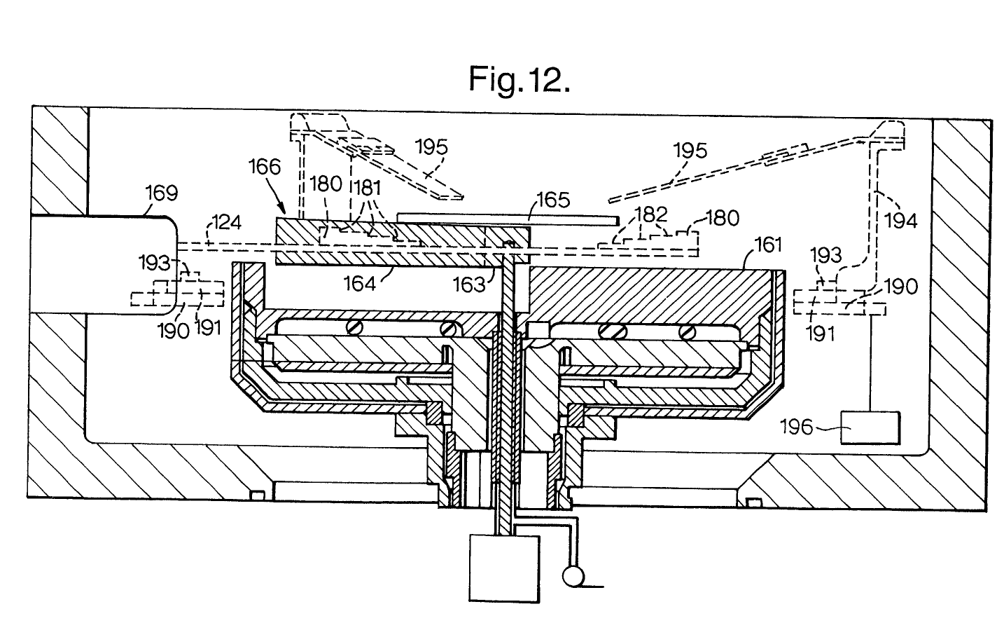

FIG. 12 shows the apparatus along the line C-C′ of FIG. 10 in its extended position;

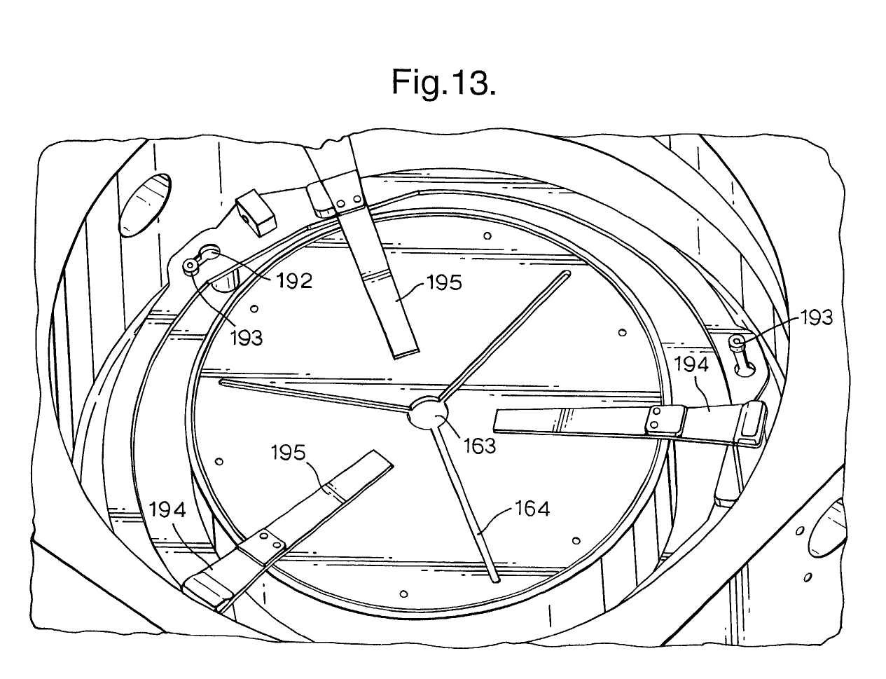

FIG. 13 shows a perspective view of FIG. 11;

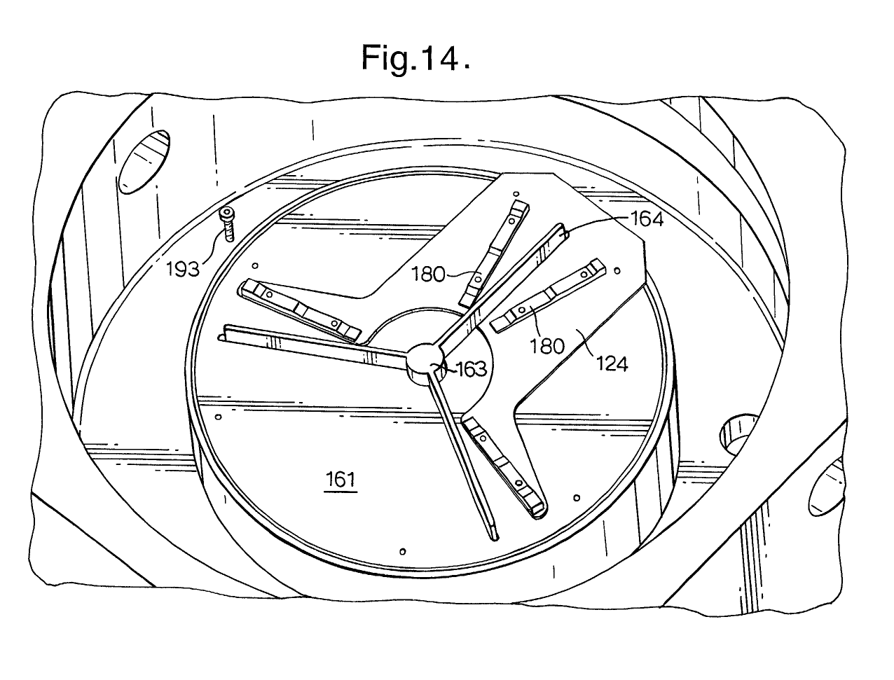

FIG. 14 shows a perspective view of FIG. 12;

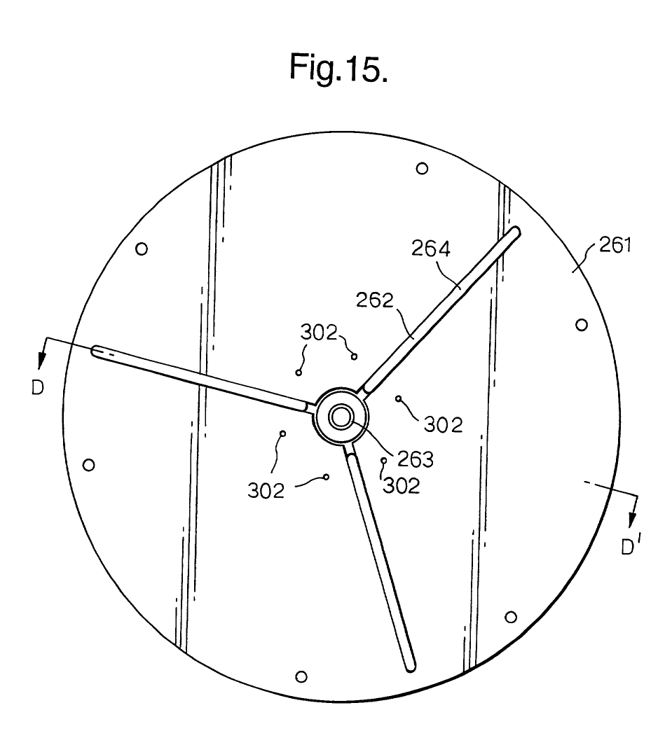

FIG. 15 is a plan view of a processing surface of a third example of the present invention;

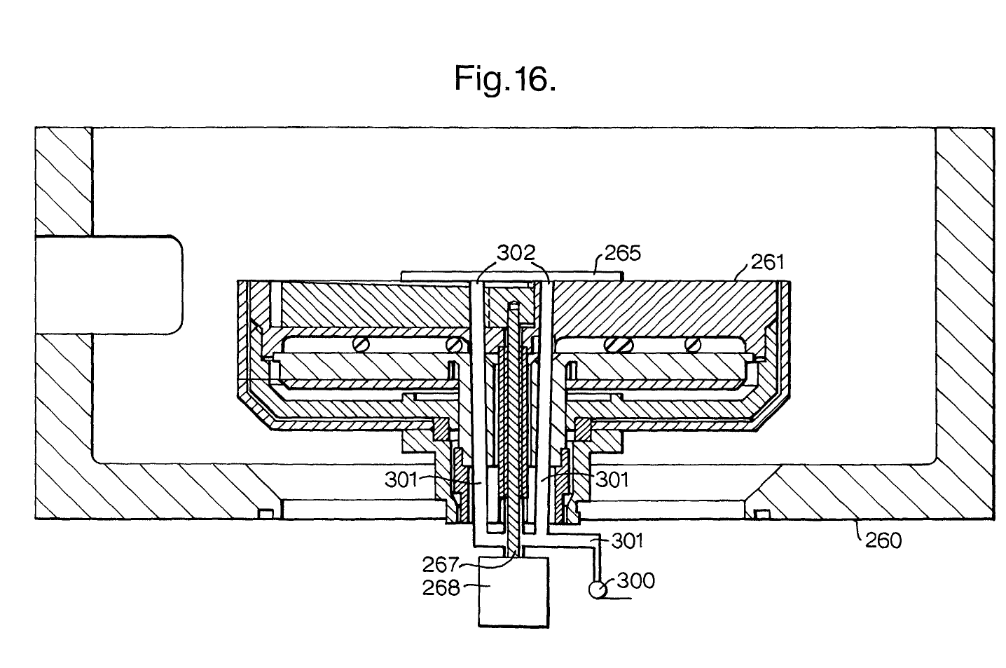

FIG. 16 shows a cross-section along the line D-D′ of the processing surface of FIG. 15;

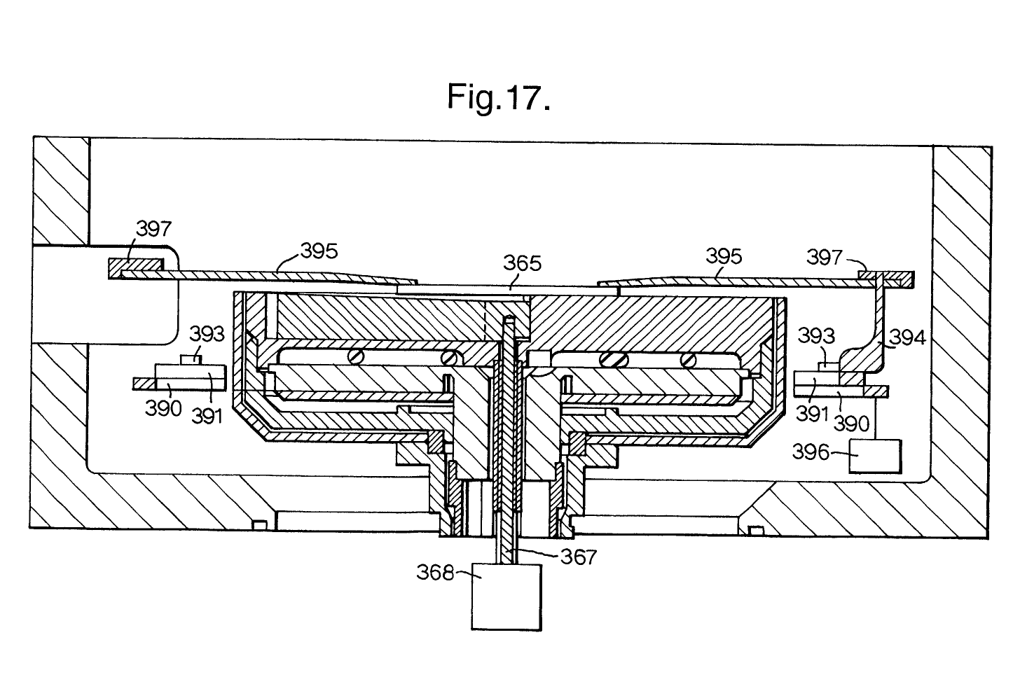

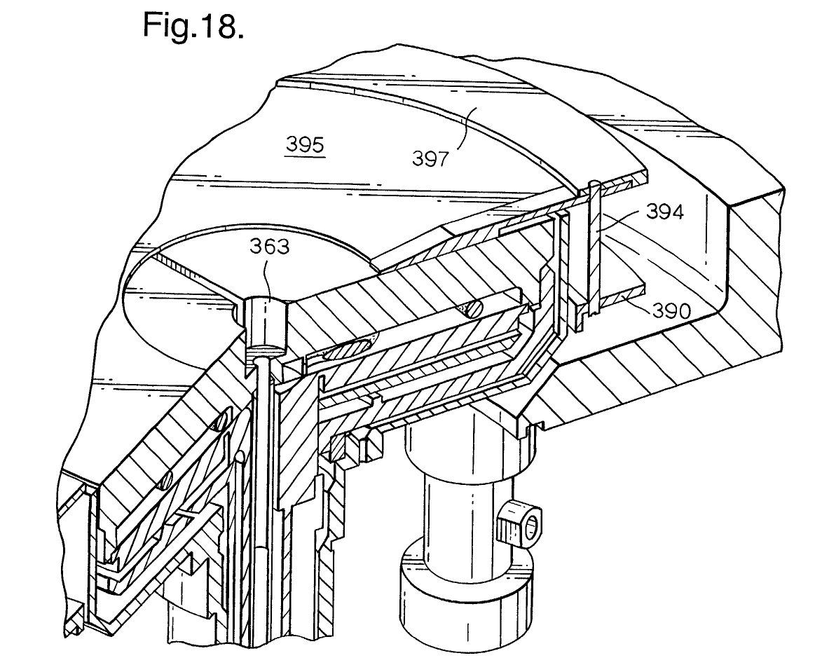

FIG. 17 is a cross-sectional view of a processing chamber according to a fourth example of the present invention; and, FIG. 18 shows a perspective cut-away view of the apparatus of FIG. 17.

An example of loading apparatus according to the present invention will now be described with reference to FIGS. 3 to 5.

FIG. 3 shows a plan view of a thin-film processing chamber 60. The chamber 60 includes a processing surface 61 upon which a substrate, indicated by the dotted lines 65, is placed. The processing surface 61 includes an aperture 62 within which is located a substrate support 66. The substrate support 66 is formed from three support limbs 64 which extend radially outwardly from a central hub 63. The processing chamber 60 may optionally also include an interface 69 to allow access to the processing surface 61.

FIG. 4 shows a cross-section along the line A-A′, when the substrate support 66 is in its retracted position. As shown, the substrate 65 lies on the processing surface 61 with the support limbs 64 being positioned either flush with, or below the processing surface 61. The central hub 63 of the substrate support 66 is coupled via a shaft 67 to an actuator, which is shown schematically at 68.

The actuator may be any suitable drive means which can impart vertical motion to the shaft 67. However, preferably it will comprise an air cylinder device coupled to the shaft 67 such that when air is pumped into the cylinder, this will cause the shaft 67, and hence the substrate support 66, to rise into the extended position shown in FIG. 5. In this position, the substrate 65 is supported by the support limbs 64.

As shown, the upper surface of the support limbs are provided at an angle with respect to the processing surface 61. Accordingly, the central hub 63 of the substrate support 66 is at a lower height than the outer end of the support limbs 64. As a consequence, the substrate 65 is supported by the edges of the substrate contacting the support limbs 64, as shown. As a result, the central hub 63 is positioned below the substrate 65 and there is no contact of any part of the substrate support 66 with the underside of the substrate 65.

In use, the actuator 68 will initially be actuated to move the substrate support 66 into the extended position. The substrate 65 is then placed on the substrate support 66, as shown in FIG. 5. The actuator is then operated to cause the substrate support 66 to gently lower into the retracted position. As a result, the substrate 65 is gently lowered onto the processing surface 61, as shown in FIG. 4. It will be realised that such operation ensures that the underside of the substrate 65 is protected from damage as there is no contact with the substrate support 66.

In the above mentioned example, the substrate 65 is positioned on the substrate support 66 by hand. However, it is also possible for a loading arm to be used to load the substrate into the processing chamber. This would generally be achieved by having the loading arm positioned in a loading chamber so as to receive the substrate. The loading arm can then be extended into the processing chamber to position the substrate 65 on the substrate support 66.

An example of a suitable loading arm will now be described with reference to FIGS. 6 to 8.

FIG. 6 shows a loading arm chamber 20 comprising a standard interface 21 conforming to the SEMI E21-91 standard. This allows the chamber 20 to be mounted in use to any suitable processing chamber interface such as the interface 69 of FIGS. 3 to 5. Before evacuating the loading chamber 20, a substrate 65 (indicated in dotted lines) such as a wafer is placed on a substrate mounting 24. The position of the clean-room interface when fitted is indicated at 22. The lid of the loading chamber is removed for clarity.

FIG. 7 shows a plan view of the loading apparatus in its extended loading position. FIG. 8 is a cross-section of FIG. 7 along a line B-B′. Substrate mounting 24 is slidably mounted on carriage 25 via a conventional linear bearing. Carriage 25 is slidably mounted on fixed rail 26, also via a conventional linear bearing.

Carriage 25 is mounted with pulleys 29,30 which rotate about axles 31 and 32 respectively. A drive belt comprising a closed loop of steel belt or wire 33 passes round the pulleys 29,30 and is fixed to the loading chamber 20 at 34, and to the substrate support 24 at 35. Therefore, linear movement of the carriage 25 (and associated pulleys 29,30) in the loading direction causes the pulleys to rotate clockwise (due to the fixing point 34). The combined linear movement of the arm 25, and driven movement of the steel belt or wire 33, causes the lefthand side 36 of the wire loop to move twice the speed and distance of carriage 25. Hence the substrate mounting 24, attached to the lefthand side 36 of the steel belt or wire 33 at fixing point 35 has a transfer distance 37 which is twice the transfer distance 38 of the carriage 25.

The telescopic movement and use of mechanical advantage allows a compact loading chamber. As can be seen from FIG. 2, the substrate mounting 24 and carriage 25 have approximately the same length in the loading direction, and in its retracted position the substrate mounting 24 lies in register with the carriage 25. This provides a particularly compact construction.

Carriage 25 is driven by a pulley drive arrangement comprising a first drive pulley 40, a second driven pulley 41 and a closed loop of steel belt or wire 42 which passes round the pulleys 41,40. The steel belt or wire 42 is attached to the arm 25 at 43. Therefore, rotation of the drive pulley 40 in an anti-clockwise direction causes the arm 25 to move in the loading direction. The drive pulley 40 is driven by a drive motor 50 shown in FIG. 4. FIG. 4 also shows the layered relationship of the slide rail 26, carriage 25 and substrate support 24.

Optical detectors 44,45 detect the presence of a hole 46 in the belt or wire 42 to indicate that the arm 25 has reached its extended or retracted position. In the extended position of FIG. 7 the hole has been detected by the detector 44. At this point, the detectors send a signal to motor 50, which causes it to stop rotating the drive pulley 40. If the optical detectors 44,45 fail to work, the extent of movement of carriage 25 is ultimately limited by mechanical stops 27,28.

One or both of the drive belts 33,42 may be mounted vertically, instead of horizontally as shown in FIGS. 2 to 4.

A typical sequence of events in a thin film processing system incorporating the loading assembly according to the invention will now be described with reference to FIG. 9.

Before operation, the wafer support is fully retracted into the loading chamber. To load a wafer into the process chamber, the following sequence of events occurs:

1. The operator opens the loading chamber door, places the substrate 65 onto the substrate mounting 24, then closes the load lock door.

2. The loading chamber is pumped down to base pressure.

3. The pneumatically operated interface 69 is opened.

4. The loading arm extends into the processing chamber 60.

5. The substrate 65 is lifted from the substrate mounting 24 by the substrate support 66 to its extended position, as shown in FIG. 9. The substrate mounting 24 is withdrawn from the chamber, and the substrate 65 is lowered onto the processing table by the substrate support 66.

6. As the substrate support reaches its fully retracted position within the loading chamber, the hole in steel belt 42 is detected by the photo diode to stop the DC motor 50.

7. The interface 69 is closed and the load lock can be vented if required.

The above sequence of events is repeated to remove the wafer from the processing chamber.

FIGS. 10 to 14 show a second example of a substrate loading apparatus according to the present invention. The apparatus shown in these diagrams is substantially the same as the apparatus of FIGS. 1 to 9 with a number of modifications.

As shown in FIG. 10, the apparatus comprises a thin film processing chamber 160 having a processing surface 161 including an aperture 162. A substrate support 166 is mounted within the aperture, the substrate support including a number of support limbs 164 extending radially outwardly from a central hub 163. As in the previous example, the central hub 163 is coupled via a shaft 167 to an actuator 168 so as to allow the substrate support 166 to move between the retracted position shown in FIG. 11 and an extended position shown in FIG. 12.

The first modification shown in FIG. 10 is the use of a modified substrate mounting 124 which is mounted to a loading arm which can be of any suitable design, such as the loading arm arrangement shown in FIGS. 6 to 8.

The substrate mounting 124 includes a number of mounting elements 180 which are coupled to the substrate mounting 124 as shown in FIG. 10. A side view of the modified substrate mounting 124 is indicated by the dotted lines in FIG. 12. As shown, the mounting elements 180 include a number of steps 181 which define a number of support surfaces 182. The mounting elements 180 are arranged so that the respective support surfaces 182 of the different mounting elements 180 cooperate to support the substrate 165. As will be realised, different sized substrates will be supported on respective different surfaces 182, with lateral motion of the substrate 165 on the support surfaces being constrained by the step 181. As a result, a given size of substrate 165 will always be supported in the same location on the substrate mounting 124. This helps ensure that the substrate 165 will always be loaded onto the processing surface 161 at a desired position.

As in the previous example, the substrate support 166 is moved to the extended position once the substrate mounting 124 has been positioned over the processing surface 161. This causes the substrate 165 to be raised clear of the substrate mounting 124, as shown in FIG. 12. The loading arm is retracted so as to move the substrate mounting 124 out of the processing chamber, thereby allowing the substrate support 166 to be lowered. This loads the substrate 165 onto the processing surface 161.

The second modification, which is shown in FIGS. 10 to 14, is the addition of a clamping system for holding the substrate 165 in position on the processing surface 161. The clamping system comprises a clamp ring 191 which is removably mounted to a support 190. The clamp ring 191 includes three shaped apertures 192 which couple to fixings 193 which are fixably mounted to the support 190. Rotation of the clamp ring 191 causes the fixings 193 to align with the larger end of the aperture 192 so that the clamp ring 191 can be lifted free of the support 190.

Coupled to the clamp ring 191 are three brackets 194 which extend vertically upwards from the ring 191. Two of the brackets 194 are shown in FIG. 11. Mounted to each bracket 194 is a resilient clamping member 195 which extends radially inwardly from the bracket 194 so as to contact the processing surface 161. These clamping members are generally formed from a plastic material, or the like, which allows the end of the clamping member to flex with respect to the bracket 194.

The support 190 is coupled to an actuator, which is shown schematically at 196. The actuator 196 allows the support to be moved between an open position, shown by the dotted lines in FIG. 12 and a clamping position shown in FIG. 11.

In the clamping position, the resilient clamping members 195 contact the edge of the upper surface of the substrate 165 thereby holding the substrate in place on the processing surface 161. As will be understood, the clamping members 195 are designed to flex slightly so as not to crush the substrate whilst still applying sufficient pressure to prevent motion of the substrate 165 with respect to the processing surface 161. When the actuator 196 is activated, this raises the support 190 to the open position shown in FIG. 12 so that the resilient clamping members 195 are lifted clear of the substrate 165. This allows the substrate 165 to be raised, as shown in FIG. 12.

It will be realised that for different size substrates 165, the clamping members 195 need to be of different lengths. Accordingly, when the size of substrate 165 to be used is altered, the clamping ring 191 is twisted and removed from the support 190 as described above. An alternative clamping ring with different size clamping members 195 is then fitted to the support 190 as required by the alternative size of substrate 165.

The third modification to the apparatus is the addition of a pressure regulator 200 which is coupled to a pipe 201 which surrounds the shaft 167. The pipe 20 is used to allow helium to flow into the aperture 162 under the control of the pressure regulator 200 of the processing surface 161. This is performed to enhance heat transfer between the substrate and the processing surface 161, when the substrate 165 is lowered onto the processing surface.

A third example of the present invention is shown in FIG. 15. In this example, a modified processing surface 261 is provided for use in a thin film processing chamber. The processing surface 261 includes an aperture 262 and a substrate support 266 mounted within the aperture. The substrate support includes a number of support limbs 264 extending radially outwardly from a central hub 263.

As in the previous examples, the central hub 263 is coupled via a shaft 267 to an actuator 268 so as to allow the substrate support 266 to be moved between a retracted position, which is shown in cross-section in FIG. 16, and an extended position (not shown).

As in the previous example, a pressure regulator 300 is provided which is coupled to a pipe 301. In this example, the pipe 301 extends up through the processing surface 261 to a number of inlet holes 302 which are shown in FIG. 15. As shown, the inlet holes 302 are circumferentially spaced apart around the aperture 262. In use, a substrate 265 which is to be etched will cover the inlet holes 302, as shown.

As in the previous example, the pressure regulator 300 is used to allow helium to flow into the pipe 301 and through the inlet holes 302. As the film processing chamber 260 is generally maintained at near vacuum pressures, the helium will simply flow into the chamber though the inlet holes 302 causing any air caught between the substrate 265 and the processing surface 261 to be expelled. The inlet holes 302 are positioned away from the aperture 262 to reduce the dissipation of helium through the aperture 262.

An example of a fourth embodiment of the present invention will now be described with reference to FIGS. 17 and 18. In this example, the clamping arrangement formed from the clamping members 195, shown for example in FIGS. 11 and 12, is replaced with an annular clamping arrangement.

Thus, as shown, a thin film processing chamber 360 having a processing surface 361 is provided with an aperture 362. A substrate support 366 is mounted within the aperture, the substrate support including a number of support limbs 264 extending radially outwardly from a central hub 363. The central hub 363 is coupled via a shaft 367 to an actuator 368 so as to allow the substrate support 366 to move between retracted and extended positions, as shown for example in previous embodiments.

In this example, a clamping system is provided for holding the substrate 365 in position on the processing surface 361.

The clamping system comprises a clamp ring 391 which is movably mounted to a support 390. The clamp ring 391 includes three shaped apertures (not shown but similar to the apertures of 192 shown in FIG. 13) which couple to fixings 393 which are fixably mounted to the support 390. Rotation of the clamp ring 391 causes the fixings 393 to align with the larger end of the aperture so that the clamp ring 391 can be lifted free of the support 390.

Coupled to the clamp ring 391 are a number of brackets 394 which extend vertically upwards from the ring 391. The brackets are mounted at their upper end to an annular wafer clamp 395 which is held in place by a retaining ring 397.

The wafer clamp 395 extends radially inwardly from the brackets 394 as shown.

In use, the support 390 is coupled to an actuator 396 which allows the support 390 to move between an open position (not shown) and a clamping position shown in FIG. 17.

In use, the support 390 is raised, as in the second embodiment to allow a substrate 365 to be positioned on the support surface 361. The actuator 396 is then operated to lower the support 390 into the clamping position. At this time, the wafer clamp 395 contacts the upper surface of the substrate 395 to hold it in place.

Because the wafer clamp 395 is an annulus, this ensures that the clamping pressure is provided around the entire circumference of the substrate 365. This provides a more secure clamping mechanism than the clamping mechanism of the second embodiment shown in FIGS. 10 to 14. In addition to this, as pressure is exerted evenly around the entire circumference of the substrate 365, this helps prevent the substrate being cracked by differences in pressure along its upper surface.

Again, as in the second embodiment it is possible to use different size of wafer clamp 395 when different sizes of substrate 165 are clamped.

It will be realised by a person skilled in the art that any of the modifications described in the second, third and fourth embodiments may be implemented separately or in any combination. The description of all the modifications within the four examples is for the case of description only and is not intended to be limiting.

We claim:

1. Apparatus for loading a substrate onto a processing surface in a thin-film processing chamber, the apparatus comprising a support which cooperates with one or more corresponding apertures in the processing surface so as to be movable between an extended position in which the support can support a substrate above the processing surface, and a retracted position in which the support is flush with or located below the processing surface, wherein the support comprises a number of limbs extending radially outwardly from a central hub, at an angle relative to the processing surface, the limbs being configured to contact the edges of different sized substrates in use so as to support the substrate in a support plane substantially parallel to the processing surface, the support plane being provided above the central hub.

2. Apparatus according to claim 1, wherein each limb defines a continuous support surface extending at an angle relative to the processing surface, each support surface contacting the edges of different sized substrates in use.

3. Apparatus according to claim 1, the apparatus further comprising a loading arm having a mounting which receives a substrate in use, the loading arm being movable between a retracted position and an extended position in which the mounting and the support cooperate such that, in use, motion of the support to the extended position causes the substrate to be supported by the support, thereby removing the substrate from the mounting.

4. Apparatus according to claim 3, wherein the mounting is located outside the chamber when the loading arm is in the retracted position.

5. Apparatus according to claim 3, wherein the mounting comprises a number of mounting elements extending radially outwardly from a central portion, each mounting element defining a number of mounting surfaces, and each mounting surface being associated with a respective mounting plane.

6. Apparatus according to claim 3, the apparatus further comprising a drive means for controllably moving the loading arm between the extended and retracted positions.

7. Apparatus according to claim 1, the apparatus further comprising an actuator for controllably moving the support between the extended and retracted positions.

8. Apparatus according to claim 1, the apparatus further comprising a clamp movable between an open position and a clamping position for clamping the substrate to the processing surface.

9. Apparatus according to claim 8, wherein the clamp comprises an annular clamping element extending radially inwardly from an outer clamping ring, the clamping ring being positioned radially outwardly from the processing surface.

10. Apparatus according to claim 9, the apparatus further comprising a clamp actuator for moving the clamp between the open and clamping positions, the clamping ring being removably mounted to the clamp actuator.

11. Apparatus according to claim 4, the apparatus further comprising a controller for controllably moving the support and the loading arm between their respective retracted and extended positions.

12. Apparatus according to claim 1, further comprising a loading assembly having a mounting which receives a substrate in use, the loading assembly being movable between a retracted position in which the mounting is outside the processing system chamber and an extended position in which the mounting is inside the processing system chamber, and wherein the mounting comprises a number of mounting elements extending substantially radially outwardly from a central position, each mounting element defining a number of mounting surfaces, and each mounting surface being associated with a respective mounting plane, and wherein the mounting and the support cooperate such that, in use, with the loading assembly in the extended position, motion of the support to the extended position causes the substrate to be supported by the support, thereby removing the substrate from the mounting.

13. Apparatus according to claim 12, wherein each mounting plane is adapted to be used when loading a respective size of substrate.

14. Apparatus according to claim 12, wherein each mounting plane is adapted to be used when loading a respective size of substrate, and wherein the mounting is adapted such that in use a substrate positioned on the mounting in the respective mounting plane will be located substantially over the centre of the processing surface when the loading assembly is in the extended position.

15. Apparatus according to claim 12, wherein the apparatus further comprising a drive means for controllably moving the loading arm between the extended and retracted positions.

16. Apparatus according to claim 12, wherein the loading assembly comprises a carriage; first drive means for driving the carriage with respect to a base; and second drive means which moves with the carriage and cooperates with the base whereby the relative movement between the carriage and the base causes the second drive means to drive the mounting with respect to the carriage.

17. Apparatus according to claim 16, wherein the carriage is slidably mounted to the base and the mounting is slidably mounted to the carriage.

18. A thin film processing system comprising one or more processing chambers in which substrates are processed, and apparatus according to claim 1 for loading the substrates.

19. A system according to claim 18, wherein the system is a plasma processing system for treatment of semiconductor wafers.
